(19) United States
(12) Patent Application Publication
(10) Pub. No.: US 2022/0198584 A1
(43) Pub. Date: Jun. 23, 2022

(54) Computer-Assisted Energy Management Method And Energy Management System

(71) Applicant: Siemens Aktiengesellschaft, München (DE)

(72) Inventors: Thomas Baumgärtner, Erlangen (DE); Stefan Langemeyer, Nürnberg (DE); Sebastian Thiem, Neustadt an der Aisch (DE); Lisa Wagner, Nürnberg (DE)

(73) Assignee: Siemens Aktiengesellschaft, München (DE)

(21) Appl. No.: 17/600,997

(22) PCT Filed: Feb. 25, 2020
(86) PCT No.: PCT/EP2020/054827

§ 371 Date: Oct. 1, 2021

(30) Foreign Application Priority Data
Apr. 3, 2019 (EP) 19167043.9

(51) Int. Cl. G06Q 50/06; G06Q 10/04

(52) U.S. Cl. CPC G06Q 50/06; G06Q 10/04

(57) ABSTRACT

Various embodiments of the teachings herein include a computer-assisted energy management method for an energy system, in which an operation of the energy system is regularly simulated according to a set call time interval for a set time horizon with a set time increment, comprising: determining whether a first parameter changes; performing an additional simulation of the operation of the energy system deviating from the set call interval based on the changed parameter; and/or within at least one critical time range in which a value of the first parameter is above a threshold value, performing a regular simulation which falls within the critical time range with a time increment which is smaller or greater than the set time increment; an operating the energy system according to either the additional simulation or the regular simulation.

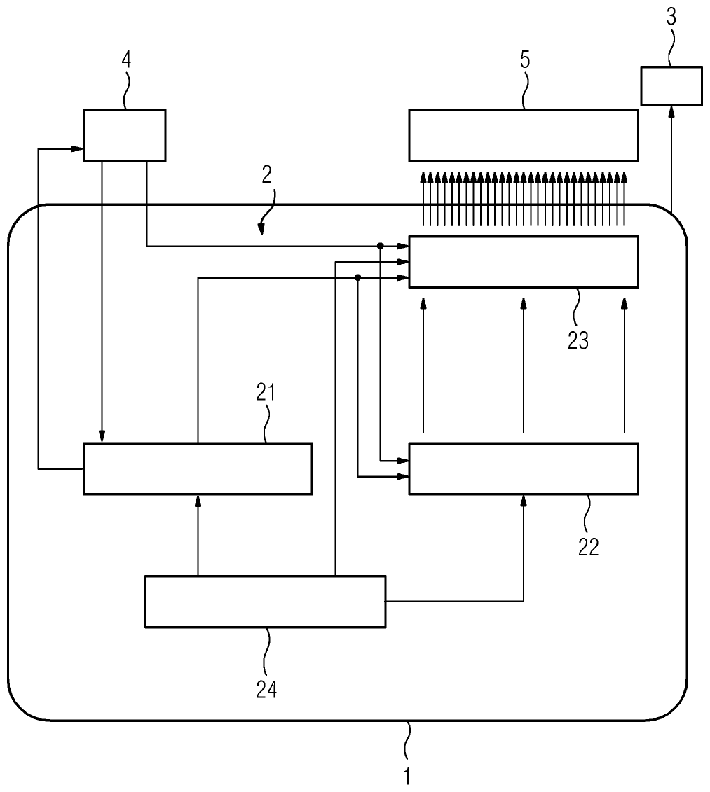

### CROSS-REFERENCE TO RELATED APPLICATIONS

This application is a U.S. National Stage Application of International Application No. PCT/EP2020/054827 filed Feb. 25, 2020, which designates the United States of America, and claims priority to EP Application No. 19167043.9 filed Apr. 3, 2019, the contents of which are hereby incorporated by reference in their entirety.

### TECHNICAL FIELD

The present disclosure relates to energy systems. Various embodiments of the teachings herein include computer-assisted energy management methods and/or energy management systems.

### BACKGROUND

Energy management methods relate to the forward planning and/or the operation of energy systems which comprise, in particular, energy generation and/or consumption units. Energy management here can comprise a forward-looking, organized and/or systematic coordination of procurement, conversion, distribution and/or use of energy, for example heat, cold, and/or electrical energy, in order to meet requirements, taking account of ecological and/or economic objectives.

Building automation systems, for example, may comprise an energy management system (Building Energy Management System; abbreviated as BEMS). Essential tasks of the energy management system here are an energy-efficient control or regulation of the components of the building infrastructure (energy system), a protection of the components of the building infrastructure, and also a provision of a required comfort, for example by means of a regulation of a room temperature of the room of the building.

One of the tasks of an energy management method or of an energy management system for an energy system is a coordination of an internal generation of an energy form within the energy system and an internal consumption of the energy form within the energy system. Energy forms can be thermal energy, in particular heat or cold, electrical energy, and/or chemical energy. A control or regulation by means of an energy management method or by means of an energy management system may be advantageous, particularly for renewably generated energy forms, for example by means of photovoltaic systems, energy storage devices and/or by means of controllable and/or regulatable loads, for example a charging of electric vehicles.

An energy management system can further comprise electrical measurements, a monitoring of the infrastructure of the energy system and a data analysis method and/or a forecasting method. An energy management method can further enable a prediction, i.e. a forecast of a load profile of the energy system, for example 24 hours in advance. For this purpose, an optimization module can be provided which simulates and thereby optimizes the corresponding load and therefore an operation of the energy system for a future time horizon, for example 24 hours. Here, the optimization module in each case performs such a simulation of the operation of the energy management system according to fixed, regular call intervals with a set temporal resolution (time increment). It is disadvantageous here that the fixed call of the simulations is not typically optimal.

### SUMMARY

The teachings of the present disclosure describe improved energy management systems and/or methods. For example, some embodiments include a computer-assisted energy management method for an energy system, in which an operation of the energy system is regularly simulated according to a set call time interval for a set time horizon with a set time increment, characterized in that, depending on a parameter, if the parameter changes, an additional simulation of the operation of the energy system deviating from the set call interval is performed depending on the changed parameter; and/or within critical time ranges in which the value of the parameter is above a preset threshold value, at least one regular simulation is performed which falls within the critical time range with a time increment which is smaller or greater than the set time increment; wherein the energy system is operated according to the additional simulation and/or the regular simulation.

In some embodiments, an additional simulation is performed if the parameter is a renewably generated electrical power, a model parameter of a component of the energy system and/or an energy price.

In some embodiments, the time increment is reduced within the critical time ranges if the parameter is a peak power of at least one component of the energy system, an emission by at least one component of the energy system, a primary energy consumption of at least one component of the energy system, a control power and/or a computing power provided by the energy system for calculating the simulations.

In some embodiments, the additional simulation is performed by means of a data center (3), in particular by means of a server and/or cloud server.

In some embodiments, a regular simulation falling within the critical time range is performed with a smaller time increment by means of a data center, in particular by means of a server and/or cloud server.

In some embodiments, the additional simulation and/or the regular simulation falling within the critical time range is/are transferred to the data center (3) if the data center (3) is mainly operated with renewably generated energy.

In some embodiments, the additional simulation is similarly performed with a smaller or greater time increment compared with the preset time increment.

In some embodiments, an additional simulation is performed with a smaller time increment within a final time range of the preset time increment of a regular simulation.

In some embodiments, the time horizon is set to 24 hours, the time increment to 15 minutes and the call interval to 24 hours; or the time horizon is set to 24 hours, the time increment to 15 minutes and the call interval to 1 hour; or the time horizon is set to 1 hour, the time increment to 1 minute and the call interval to 1 minute.

In some embodiments, the regular simulations and/or the additional simulation is/are calculated by means of an optimization method.

As another example, some embodiments include an energy management system (1) for an energy system, comprising an optimization module (2) by means of which an operation of the energy system is regularly simulatable according to a preset call time interval for a preset time horizon with a preset time increment, characterized in that, depending on a parameter, in the event of a change in the parameter, an additional simulation of the operation of the energy system deviating from the preset call interval is performable by means of the optimization module (2) depending on the changed parameter; and/or within critical time ranges in which the value of the parameter is above a preset threshold value, at least one regular simulation which falls within the critical time range is performable by means of the optimization module (2) with a time increment which is smaller or greater than the preset time increment; wherein the energy system is operable by the energy management system according to the additional simulation and/or the regular simulation.

In some embodiments, an additional simulation is performable if the parameter is a renewably generated electrical power, a model parameter of a component of the energy system and/or an energy price.

In some embodiments, the time increment is reducible within the critical range if the parameter is a peak power of at least one component of the energy system, an emission by at least one component of the energy system, a primary energy consumption of at least one component of the energy system, a control power provided by the energy system and/or a computing power for calculating the simulations.

In some embodiments, there is a data interface for exchanging data containers with an external energy network and/or an external energy market (4) outside the energy management system.

In some embodiments, an additional simulation and/or a change in the time increment of one of the regular simulations is performable by means of the optimization module (2) depending on data exchanged by means of containers via the data interface.

### BRIEF DESCRIPTION OF THE DRAWINGS

Further features, details, and advantages of various embodiments of the teachings of the present disclosure are set out in the following description of example embodiments and with reference to the drawing. The single figure shows schematically an energy management system incorporating teachings of the present disclosure.

### DETAILED DESCRIPTION

In some example computer-assisted energy management methods incorporating teachings of the present disclosure for an energy system, an operation of the energy system is regularly simulated according to a set call time interval for a set time horizon with a set time increment. The energy management method according to the invention is characterized in that, depending on a parameter,

if the parameter changes, an additional simulation of the operation of the energy system deviating from the set call interval is performed depending on the changed parameter; and/or

within critical time ranges in which the value of the parameter is above a preset threshold value, at least one regular simulation is performed which falls within the critical time range with a time increment which is smaller or greater than the set time increment; wherein

the energy system is operated according to the additional simulation and/or the regular simulation.

The operation may be calculated or simulated by means of an optimization so that the terms simulation and optimization can be equivalent in the present disclosure. In other words, the simulation is typically an optimization.

In some embodiments, the operation of the energy system is initially regularly simulated, for example through the performance of an optimization, at fixed call times, i.e. according to the fixed call interval. In other words, a time interval corresponding to the call interval lies between two simulations. The operation of the energy system can comprise one or more components of the energy system. Each of the regular simulations is performed for a fixed time horizon and with a fixed discretization of the time coordinate. The discretization of the time coordinate corresponds to the time increment. These regularly performed simulations are characterized in that they are performed at fixed and regular times with a fixed time horizon and a fixed time increment.

The simulations are computer-assisted and can be performed or executed by means of an optimization module, for example a computing device. The optimization module can similarly be referred to as a simulation module. By means of the optimization module, an optimal operation can be calculated or simulated by means of a mathematical/numerical optimization based on a target function which is intended to be maximized or minimized. The optimizations/simulations are extremely complex for typical energy systems and can therefore be performed or executed only in a computer-assisted manner. The simulations form the basis for a future control or regulation of the energy system in relation to the start time of the simulation. In other words, the energy system is operated for a fixed time period according to the simulation. The present operation of the energy system is updated by means of a subsequent simulation and is operated according to the preceding simulation until the occurrence of the next simulation.

In some embodiments, an additional simulation in relation to the regular simulations is performed depending on the parameter if a change in the parameter occurs and/or the time increment decreases or increases within specific critical ranges of regular simulations falling within the critical ranges. Whether an additional simulation is a performed and/or the time increment of a regular simulation is reduced or increased, i.e. changed, depends on the physical substance of the parameter itself (not only on its value), or on the type of parameter involved. The parameter therefore characterizes different quantities, in particular different physical quantities.

The time increment is essentially changed (increased or decreased) in relation to the time increment set for the regular simulations. The parameter can further comprise a plurality of physical quantities, wherein a change can occur for one of the physical quantities and therefore an additional simulation is performed, and a critical time range can be present for a further of the physical quantities and therefore a regular simulation is performed with a changed time increment. In other words, the performance of an additional simulation and/or the change in the time increment for one of the regular simulations, depends on the parameter. Both characteristics can therefore similarly be present for one parameter. In this sense, the parameter thus represents one or more parameters.

In some embodiments, it may be advantageous, for example, to perform an additional simulation in the event of a change in a renewably generated electrical power. The parameter here is therefore the physical quantity of the renewably generated electrical power. Conversely, if the parameter is a peak power of a component of the energy system which lies within the critical time range above a set threshold value and in this sense is therefore increased, the time increment of the regular simulation falling within this critical time range is therefore reduced.

In some embodiments, the known rigid concept of the regular simulations is broken up and the energy management can respond dynamically to changes in the parameter, in particular to changes in physical quantities characterizing the operation of the energy system. If a change occurs, this change is not included in the next regular simulation as in the prior art, but an additional simulation is performed according to the invention which is arranged, for example, temporally between two regular simulations. In other words, the additional simulation is triggered or instigated by the change in the at least one parameter.

In some embodiments, a higher or lower temporal resolution is anticipated in critical time ranges. In other words, the time increment is reduced or increased in the critical time ranges within a regular simulation which falls temporally within the critical time range. A dynamic response to critical time ranges and therefore critical values of the parameter may be similarly enabled as a result. The critical time ranges are characterized here in that the value of the parameter, for example the value of a peak power, is above a threshold value set for this parameter. In other words, the value of the parameter is increased within the critical time ranges. If a critical time range is to be characterized in that the value of the parameter lies below a threshold value, this can always be converted through formation of the reciprocals into a parameter whose value lies above a threshold value. In other words, the critical time ranges are characterized in that the value of at least one parameter lies outside a normal range set for this parameter. If one of the regular simulations then falls temporally within a critical time range of this type, the time increment of this simulation is changed, typically reduced. An increased temporal resolution can thereby be achieved in the critical time ranges. The simulation is thereby improved, particularly in critical time ranges, as a result of which the energy management method is improved overall.

In some embodiments, the parameter is not restricted to internal quantities or physical quantities within the energy system. In other words, the parameter can be or comprise a physical quantity within the energy system or outside the energy system. One example of a parameter outside the energy system is a renewable electrical power or energy generated or provided outside the energy system. If a change occurs in this externally generated renewably generated electrical power, an additional simulation is started or performed according to the present invention.

An example energy management system for an energy system comprises at least one optimization module by means of which an operation of the energy system is regularly simulatable according to a preset call time interval for a preset time horizon with a preset time increment. In some embodiments, depending on a parameter,

if the parameter changes, an additional simulation of the operation of the energy system deviating from the preset call interval can be performed by means of the optimization module depending on the changed parameter; and/or

within critical time ranges in which the value of the parameter is above a preset threshold value, at least one regular simulation which falls within the critical time range can be performed by means of the optimization module with a time increment which is smaller or greater than the preset time increment; wherein

the energy system is operable by the energy management system according to the additional simulation and/or the regular simulation.

The optimization module can similarly be referred to as a simulation module and/or a planning module. The optimization module can be a computing device. The optimization module can further comprise at least a first and second optimization module, wherein the first optimization module is provided or designed for the additional simulation, and the second optimization module for the regular simulations with a smaller time increment. The optimization module can further be subdivided into further modules or can comprise further modules which in each case perform a specific simulation. A module of this type can thus be provided in each case for the day-ahead optimization, for the intraday optimization and/or for the load manager optimization (short-term optimization).

The optimization module can further comprise further specialized modules, for example a forecasting module, a configuration module and/or a model parameter module. In other words, the optimization module can be designed as modular in relation to its different tasks. The energy management system can further comprise a control device or a regulating device which is coupled to the optimization module at least in respect of the exchange of data, wherein the control device or the regulating device is designed to control or regulate the components of the energy system on the basis of one or more of the simulations. The energy management systems described herein offer advantages analogous to those of the energy management.

In some embodiments, an additional simulation is performed if the parameter is a renewably generated electrical power, a model parameter of a component of the energy system and/or an energy price. In other words, an additional simulation can be performed by means of the optimization module if the parameter is a renewably generated electrical power, a model parameter of a component of the energy system and/or an energy price.

In other words, an additional simulation deviating from the temporal sequence of the regular simulations is performed or triggered or started if a renewably generated electrical power changes and/or a model parameter changes and/or an energy price changes. The renewably generated electrical power can be generated or provided here within the energy system or outside the energy system. If, for example, a surplus of renewably generated electrical power or energy is present due to a change, for example due to higher solar radiation, an additional simulation is performed or triggered or started, taking account of the new and therefore more up-to-date value of the renewably generated electrical power/energy. A similar method can be carried out if an energy price changes, particularly in the event of sudden changes.

A change in a model parameter can occur due to a model parameter adjustment which known energy management methods perform. In model-based energy management systems, the energy system which is to be controlled or regulated, or the components thereof, are essentially modelled by means of a mathematical model. The known models are parameterizable here, for example in order to map different types of refrigeration machines, for example from different manufacturers, or different operating points and integrate them into the simulations. In the model parameter adjustment, which typically takes place in an automated manner, the model parameters, for example for the refrigeration machine, are adjusted and therefore changed during the operation of the energy system or the component to be modelled. Following a change of this type, i.e. following a parameter adjustment of this type, it is therefore advantageous to perform an additional simulation, taking account of the new value of the parameter.

In some embodiments, the time increment is reduced within the critical time ranges if the parameter is a peak power of at least one component of the energy system, an emission by at least one component of the energy system, a primary energy consumption of at least one component of the energy system, a control power provided by the energy system and/or a computing power for calculating the simulations. In other words, the time increment is reducible within the critical range if the parameter is a peak power of at least one component of the energy system, an emission by at least one component of the energy system, a primary energy consumption of at least one component of the energy system, a control power provided by the energy system and/or a computing power for calculating the simulations.

In other words, the time increment, i.e. the temporal resolution on which the simulation is based, is reduced in the event of an increased peak power of a component of the energy system and/or in the event of an increased emission by at least one component of the energy system and/or in the event of an increased primary energy consumption of at least one component of the energy system and/or in the event of an increased control power provided by the energy system and/or in the event of an increased or in the event of an available increased computing power.

The time range around a peak power, for example, is similarly a critical time range if the maximum provided peak power is violated within the time range, i.e. if the peak power is above its set threshold value in this time range. The threshold value of the peak power is exceeded, for example, if an energy storage device, in particular a battery storage device, is discharged more quickly than intended. Significantly higher costs are therefore incurred in the operation of the energy system. These could be at least partially avoided by providing a battery buffer.

In some embodiments, a simulation having a higher temporal resolution is performed in these critical time ranges, so that further violations of the threshold value of the peak power can thereby be avoided. As a result, the battery buffer can be designed as smaller or at best can be completely eliminated. If such critical time ranges are recognized, a smaller time increment can be permanently provided for them. In other words, they must simply be recognized when their threshold value is exceeded for the first time. Further exceedances can then be avoided due to the smaller time increment, since the energy system and its components can thereby be operated in an improved manner.

The increased peak power can similarly be characterized by increased shadow prices. An optimization method, for example, is carried out for or during the simulation. One solution of the optimization method or the optimization is provided by the shadow prices of the associated energy forms. If critical time ranges with increased shadow prices are recognized therefrom, it is advantageous to reduce the time increment for the regular simulations falling within these critical time ranges. In other words, the energy management system anticipates a higher temporal resolution compared with the set temporal resolution in the critical time ranges. The energy system can be operated more efficiently as a result. A load manager optimization, for example, has a time increment of 1 minute. The load manager optimization is therefore carried out in the critical ranges with a smaller time increment, i.e. with a time increment of less than 1 minute.

In some embodiments, the additional simulation is performed by means of a data center, in particular by means of a distributed data center and/or a server and/or cloud server. In some embodiments, a regular simulation falling within the critical time range is carried out with a smaller time increment by means of a data center, in particular by means of a distributed data center and/or server and/or cloud server. In other words, the additional simulation or the simulation with the smaller time increment is transferred to the data center. This may be advantageous given that already installed energy management systems typically do not have sufficient computing power for an additional simulation and/or a reduction of the time increment. Through the transfer of these simulations to a, if necessary external, data center, the methods can similarly be used or implemented in such energy management systems with, in this sense, limited computing capacity.

In some embodiments, the additional simulation and/or the regular simulation falling within the critical time range is/are transferred to the data center if the data center is mainly operated with renewably generated energy. In other words, the simulations are transferred to the data center depending on ecological considerations. The transfer could further be more favorable at times when the data center is operated, for example, with solar power. In this example, it is therefore advantageous to transfer the simulations during the daytime, in particular around midday, and not at night. Simulations could thus be performed with a higher temporal resolution at midday. In some embodiments, the energy management system could provide computing power, for example for further energy management systems.

In other words, the transfer of the simulations to the data center can be dynamic. This may be advantageous in that the flexible availability of computing power can depend on the utilization of the data center. An operator of the data center could therefore control the provision of the computing power with dynamic charges. The energy management system can respond to this through the dynamic transfer. The grid-supporting operation of the data center, for example in the event of an overload, in the event of an outage or in the event of a consideration of volatile generation of renewable energies could similarly result in a time-limited bottleneck in the computing power. In such a case, the energy management system or the energy management method can transfer the simulations to the external data center and perform them always with the same temporal precision and/or a greater time increment and/or with a longer call interval. As a result, the simulations or an optimization problem underlying the simulations can advantageously be calculated with less external computing power.

In some embodiments, the additional simulation is similarly performed with a smaller or greater time increment compared with the preset time increment. The additional simulation may be improved. Typically, the smaller the time increment, the more precise or more efficient the simulation is in terms of the operation of the energy system. However, if less computing power is available internally and/or externally, it may be advantageous to increase the time increment in order to nevertheless perform a simulation despite the restricted computing resources.

In some embodiments, an additional simulation is performed with a smaller time increment within a final time range of the preset time increment of a regular simulation. In other words, the final range of the preset time increment is typically a critical time range. At the end of the time increment which is, for example, 15 minutes, energy must typically be additionally generated or provided and/or consumed aside from the planning or forecast. This effect may be reduced by performing an additional simulation with a smaller time increment in these critical time ranges.

In some embodiments, the time horizon is set to 24 hours, the time increment to 15 minutes and the call interval to 24 hours; or the time horizon is set to 24 hours, the time increment to 15 minutes and the call interval to 1 hour; or the time horizon is set to 1 hour, the time increment to 1 minute and the call interval to 1 minute. In other words, a day-ahead optimization or an intraday optimization or a load manager optimization (short-term optimization) is performed.

The day-ahead optimization has a time horizon of 24 hours. The operation of the energy system is thereby simulated or calculated for the next 24 hours. The day-ahead optimization further has a time increment of 15 minutes. In other words, the time horizon of 24 hours is subdivided or discretized into 15-minute time intervals for the simulation. The call interval in the day-ahead optimization is 24 hours. In other words, a new day-ahead optimization is performed or started every 24 hours, so that the day-ahead optimization is performed daily.

In contrast to the day-ahead optimization, the intraday optimization has a call interval of 1 hour. In other words, an intraday optimization is performed or started every hour. The load manager optimization has a time horizon of 1 hour. The operation of the energy system is thereby simulated or calculated for the next hour. The time increment of a load manager optimization is accordingly reduced to 1 minute. The load manager optimization is called or started every minute, so that the call interval of the load manager optimization is 1 minute.

In some embodiments, the regular simulations and/or the additional simulation is/are calculated by means of an optimization method. An optimization method or an optimization in the sense of the present disclosure is a mathematical and/or numerical or computer-assisted optimization based on a target function. The target function can model the energy system and its components here. The target function has variables and model parameters for this purpose. The target function is minimized or maximized, wherein no exact minimum or maximum typically needs to be present, but instead it suffices to approximate the extreme values except for a preset error.

In other words, the values of the variables of the target function are defined in such a way that the target function is minimized or maximized. In this sense, optimal means that the target function is minimized or maximized. The target function may be the total carbon dioxide emission of the energy system, the total primary energy consumption of the energy system and/or the costs/operating costs of the energy system. The optimization of the target function is typically performed under a plurality of secondary conditions which the variables and/or model parameters of the target function must satisfy. The optimization, i.e. the determination of the optimal target function and therefore the optimal values of the variables of the target function is typically possible for complex systems, for example, in this case energy systems, only in a computer-assisted manner. The operation of the energy system is optimized here by means of the optimization, for example with a view to the highest possible energy efficiency of the energy system, the lowest possible carbon dioxide emission and/or the lowest possible costs/operating costs.

In other words, an optimal future operation of the energy system may be simulated or calculated through the regular simulations and/or the additional simulation. The energy system can be operated optimally in future by means of the simulations. In particular, the day-ahead optimization, the intraday optimization, the load manager optimization and the additional simulations are calculated by means of an optimization. The simulation/optimization is required, in particular, given that countless energy systems cannot be installed or operated in order to determine an optimally operated energy system. The model parameters provided for the optimization which, for example, parameterize or initialize the target function are typically physical quantities which can be captured at a given time or from historical data by means of measurements on the present energy system. In other words, the parameterization and therefore the target function are based on physically captured measurement data of the energy system. It is thereby ensured that the energy system is physically realistically modelled by the target function. The computer-assisted optimization therefore provides an important technical tool for operating energy systems as efficiently as possible in the context of an energy management method.

In some embodiments, the energy management system has at least one data interface for exchanging data containers with an external energy network and/or an external energy market outside the energy management system. The data container can be a blockchain. In other words, the data can be exchanged via the data interface by means of a blockchain.

In some embodiments, the additional simulation can be triggered or started or instigated by means of the data interface on the basis of an energy market signal. This takes place, for example, if the external energy market conveys the information by means of the data interface that a surplus of renewably generated electrical power/energy is present or a jump in prices has occurred.

An additional simulation could further be instigated by a dynamic energy market, for example a peer-to-peer based energy market. Corresponding information is transmitted here via the data interface to the energy management system to instigate the additional simulation. If a problem occurs, for example an unforeseen feed-in surplus, particularly within a local power distribution network, the energy management system can advantageously respond promptly and optimize the operation of the energy system in this respect and through the performance of an additional simulation. From a microeconomic perspective, the energy system which responds promptly or as quickly as possible to the change within the energy market is advantageously positioned in such a scenario. From a macroeconomic perspective, it may be similarly advantageous to alleviate or eliminate the problematic state as quickly as possible. To do this, for example, the energy management system starts an additional simulation/optimization with a comparatively short time horizon, for example for the next 5 minutes.

The arrows in the figure in each case indicate a possible data exchange between the components shown. The data exchanges can be two-way or one-way and can be performed by means of data containers, in particular by means of blockchains. The energy management system 1 shown in the figure comprises an optimization module 2. The optimization module 2 is designed to regularly optimize/simulate an operation of an energy system which comprises, for example, the energy management system, for future times for a set time horizon with a set time increment according to a set call time interval.

These optimizations/simulations performed according to a set pattern are referred to as regular simulations. A plurality of different regular simulations can be performed here. These include, for example, a day-ahead optimization, an intraday optimization and/or a load manager optimization. The day-ahead optimization, the intraday optimization and the load manager optimization are regular simulations. The optimization module 2 has a module 21, . . . ,24 for each of the aforementioned regular simulations. A first module 21 is provided for the day-ahead optimization. A second module 22 is provided for the intraday optimization. A third module 23 is provided for the load manager optimization. The optimization module 2 further has a fourth module which is provided, for example, for a prediction of the operation of the energy management system (forecasting module), for a configuration of the energy system and/or its components, and/or for the capture and/or provision and/or storage of model parameters for the simulations. It is similarly evident from the figure that the modules 21, . . . , 24 can exchange data with one another.

A control device 5 is further shown in the figure. The energy system or the energy management system 1 can comprise the control device 5. The control device is designed to control and/or regulate the components of the energy system and therefore the operation of the energy system on the basis of the simulations of the energy management system or on the basis of an energy management method as described herein.

The energy management system 1 further has a data interface to an external data center 3. The data center 3 is, in particular, a distributed data center, a server and/or a cloud server. The data interface between the energy management system 1 and the data center 3 is designed in such a way that simulations can be transferred to the data center and the result of the simulations can in turn be transmitted back to the energy management system 1. A transfer may be advantageous, for example, if the energy management system 1 has too little computing power at the time of the simulation, for example turbo modes of processors are not available, or the total data quantities are too vast.

An energy market 4, in particular a local energy market, is further shown in the figure. The energy management system 1 is coupled to the energy market 4 similarly for the data exchange. The individual modules 21, . . . ,24 of the optimization module 2 can be coupled here to the energy market 4 for the data exchange. In other words, the energy management system 1 is connected to the energy market 4 for exchanging data, information or data containers. The data exchange with the energy market 4 can preferably be performed by means of a blockchain.

The energy management system 1 is designed to carry out an energy management method as described herein. In particular, the optimization module 2 which the energy management system 1 comprises is already designed to carry out an energy management method. An operation of the energy management system can thus be regularly simulated by means of the optimization module 2 according to a preset call time interval for a preset time horizon with a preset time increment.

Depending on a parameter, i.e., for example, depending on the type of the parameter and/or the value of the parameter,

in the event of a change in the parameter, an additional simulation of the operation of the energy system deviating from the preset call interval can be performed by means of the optimization module 2 depending on the changed parameter; and/or

within critical time ranges in which the value of the parameter is above a preset threshold value, at least one regular simulation which falls within the critical time range can be performed by means of the optimization module 2 with a time increment which is smaller or greater than the preset time increment.

In other words, the optimization module 2 is designed to perform an additional simulation deviating from the regular and set sequence of simulations and/or to change, preferably to reduce, the time increment of the regular simulations within the critical time ranges depending on at least one parameter (or a plurality of parameters). The trigger for the additional simulation is a change in the value of the parameter, for example a change in a renewably generated electrical power/energy. The trigger for the use of a smaller time increment is the presence of a critical time range. Whether an additional simulation and/or a regular simulation with a reduced time increment is triggered depends here on the type of the parameter. Both of the aforementioned characteristics can similarly be triggered. Furthermore, the additional simulation can similarly be performed with a smaller time increment compared with the set time increment.

The energy management system 1 or the optimization module 2 is designed, for example, to perform an additional simulation in the event of a change in a renewably generated electrical power/energy and/or in the event of a change in a model parameter of a component of the energy system and/or an energy price. A model parameter can be changed by means of an automated parameter adjustment. A change in the energy price can be communicated by the energy market 4 to the energy management system 1 and/or to the optimization module 2.

The energy management system 1 can further be designed to reduce the time increment within the critical time ranges if the parameter is a peak power of at least one component of the energy system, an emission by at least one component of the energy system, a primary energy consumption of at least one component of the energy system, a control power and/or a computing power provided by the energy system for calculating the simulations. If, for example, the peak power is increased in relation to its threshold value in a time range, the time increment is reduced and the temporal resolution is therefore improved.

In the sense described above, the performance of an additional simulation or the performance of a regular simulation with a reduced time increment depends on the type of the parameter, for example on whether the parameter is a renewably generated electrical power/energy or a peak power. As a result, the energy management system 1 can respond dynamically to changes or modifications of parameters, whether these are internal or external in relation to the energy system, whereby the operation of the energy system becomes more efficient and is therefore improved. In other words, the known rigid or set regular simulations are dynamized by the present invention or by one of its designs.

Although the teachings herein have been illustrated and described in detail by means of preferred example embodiments, the scope of the disclosure is not limited by the disclosed examples, or other variations may be derived therefrom by the person skilled in the art without departing the scope thereof.

### REFERENCE NUMBER LIST

1 Energy management system
2 Simulation module
3 Data center
4 Energy market
5 Control device
21 Day-ahead optimization
22 Intraday optimization
23 Load manager optimization
24 Forecasting module

What is claimed is:

1. A computer-assisted energy management method for an energy system, in which an operation of the energy system is regularly simulated according to a set call time interval for a set time horizon with a set time increment, the method comprising:
determining whether a first parameter changes;
performing an additional simulation of the operation of the energy system deviating from the set call interval based on the changed parameter; and/or
within at least one critical time range in which value of the parameter is above a threshold value, performing a regular simulation which falls within the critical time range with a time increment which is smaller or greater than the set time increment; and
operating the energy system according to either the additional simulation or the regular simulation.

2. The computer-assisted energy management method as claimed in claim 1, further comprising performing the additional simulation if the parameter is a renewably generated electrical power, a model parameter of a component of the energy system, and/or an energy price.

3. The computer-assisted energy management method as claimed in claim 1, further comprising reducing the time increment within the critical time ranges if the parameter is a peak power of at least one component of the energy system, an emission by at least one component of the energy system, a primary energy consumption of at least one component of the energy system, a control power, and/or a computing power provided by the energy system for calculating the simulations.

4. The computer-assisted energy management method as claimed in claim 1, wherein the additional simulation is performed by a data center.

5. The computer-assisted energy management method as claimed in claim 1, wherein the regular simulation falling within the critical time range is performed with a smaller time increment by a data center.

6. The computer-assisted energy management method as claimed in claim 4, wherein the additional simulation is transferred to the data center if the data center is mainly operated with renewably generated energy.

7. The computer-assisted energy management method as claimed in claim 1, wherein the additional simulation is performed with a smaller or greater time increment compared with the preset time increment.

8. The computer-assisted energy management method as claimed in claim 1, wherein the additional simulation is performed with a smaller time increment within a final time range of the preset time increment of a regular simulation.

9. The computer-assisted energy management method as claimed in claim 1, wherein the time horizon is set to 24 hours, the time increment to 15 minutes and the call interval to 24 hours.

10. The computer-assisted energy management method as claimed in 1, the regular simulations and/or the additional simulation is/are calculated using an optimization method.

11. An energy management system for an energy system, comprising:
an optimization module programmed to simulate an operation of the energy system according to a preset call time interval for a preset time horizon with a preset time increment; wherein
in the event of a change in parameter, the optimization module performs an additional simulation of the operation of the energy system deviating from the preset call interval based on the changed parameter; and/or
if within critical time ranges the value of the parameter is above a preset threshold value, the optimization module performs at least one regular simulation which falls within the critical time range with a time increment which is smaller or greater than the preset time increment;
wherein the energy system is then operated by the energy management system according to the additional simulation and/or the regular simulation.

12. The energy management system as claimed in claim 11, wherein an additional simulation is performed if the parameter is a renewably generated electrical power, a model parameter of a component of the energy system, and/or an energy price.

13. The energy management system as claimed in claim 11, wherein the time increment is reduced within the critical range if the parameter is a peak power of at least one component of the energy system, an emission by at least one component of the energy system, a primary energy consumption of at least one component of the energy system, a control power provided by the energy system, and/or a computing power for calculating the simulations.

14. The energy management system as claimed in claim 11, further comprising a data interface for exchanging data containers with an external energy network and/or an external energy market outside the energy management system.

15. The energy management system as claimed in claim 14, wherein the optimization module performs an additional simulation and/or a change in the time increment of one of the regular simulations depending on data exchanged by means of containers via the data interface.

16. The computer-assisted energy management method as claimed in claim 5, the regular simulation falling within the critical time range is transferred to the data center only if the data center is mainly operated with renewably generated energy.
